(19) United States
(12) Patent Application Publication
(10) Pub. No.: US 2012/0161705 A1
(43) Pub. Date: Jun. 28, 2012

(54) DOCKING STATION MODULE FOR PORTABLE COMMUNICATION DEVICE

(75) Inventor: Wei-Yin Huang, Taoyuan Hsien (TW)

(73) Assignee: TECO IMAGE SYSTEM CO., LTD., Taoyuan Hsien (TW)

(21) Appl. No.: 13/038,161

(22) Filed: Mar. 1, 2011

(30) Foreign Application Priority Data
Dec. 28, 2010 (TW) 099146300

(51) Int. Cl. H02J 7/00

(52) U.S. Cl. 320/115

(57) ABSTRACT

A docking station module for portable communication device is disclosed. The docking station module includes a main module configured to connect to a portable communication device and supply power to the portable communication device, and at least one peripheral device adapter module detachably connected to the main module and a peripheral device for allowing the data to be transferred between the portable communication device and the peripheral device in an one-way manner or in a two-way manner and enabling the peripheral device adapter module to execute an extension function.

### CLAIM OF PRIORITY

This application claims priority to Taiwanese Patent Application No. 099146300 filed on Dec. 28, 2010.

### FIELD OF THE INVENTION

The invention is related to a docking station module, and more particularly to a docking station module for portable communication device.

### MOTIVE OF THE INVENTION

With the advancement of technology, electronic devices, e.g. smart phones, are featured with a thin and small mechanical structure, great versatility, high-speed processing speed, and excellent portability. Generally speaking, smart phones are capable of playing video, conducting bluetooth communication, capturing digital image, expanding memory card storage, and providing wireless network service in addition to the basic telephone communication function. In order to enhance the utility and convenience of the smart phone, the integrated charging dock for smart phone have been developed. The integrated charging dock for smart phone can be used to charge the smart phone. Also, the integrated charging dock for smart phone can be used to connect to peripheral devices, such as keyboard, mouse, monitor, speaker, USB device, and network device. Thus, the smart phone can conduct transfer data with peripheral devices and share data with the peripheral devices by the integrated charging dock.

Nonetheless, the functions of conventional charging dock for smart phone have to be preset and predetermined prior to the design stage, and all of the essential elements of the charging dock have to be embedded in the same circuit board of the charging dock. Thus, the manufacturing cost of the integrated charging dock is considerably high. What is worse, as an essential element of the integrated charging dock is malfunctioned, the repairman can not accomplish the repair operation for a single element, resulting in the inconvenience in repair. Besides, the integrated charging dock is uniquely designed for a single model of smart phone. Thus, the integrated charging dock is not compatible with other models of smart phone. Furthermore, different users (individuals, corporations) require different functions. However, users can not select the functions of the integrated charging dock by themselves. In some occasions, users have to buy integrated charging dock which incorporates undesirable functions. Thus, integrated charging dock can not meet the demands of all kinds of users, and can not extensively appeal to the user.

### SUMMARY OF THE INVENTION

An object of the invention is to provide a docking station module for portable communication device that is implemented by a main module or a main module as well as at least one peripheral device adapter module for lowering the cost and enhancing the feasibility of maintenance.

Another object of the invention is to provide a docking station module for portable communication device that can connect to a plurality of portable communication devices for selectively receiving the data signals from the portable communication devices and transmitting the data signals to the portable communication devices. Also, the inventive docking station module can allow the peripheral device adapter module to be detached from the docking station module or attached to the docking station module depending on user's demands.

To this end, a broader aspect of the invention is to provide a docking station module for portable communication device. The docking station module includes a main module configured to connect to a portable communication device for charging the portable communication device; and a peripheral device adapter module detachably connected to the main module and the peripheral device and configured to allow the one-way or two-way data transfer between the portable communication device and the peripheral device and execute the extension function of the peripheral device adapter module.

To this end, another broader aspect of the invention is to provide a docking station module for portable communication device. The docking station module includes a main module configured to connect to the portable communication device for charging the portable communication device; and a plurality of peripheral device adapter module detachably connected in series with each other and connected to the main module, and respectively connected to a plurality of peripheral devices. The peripheral device adapter modules are configured to allow the one-way or two-way data transfer between the peripheral devices and the portable communication device and execute the extension function of the peripheral device adapter modules.

To this end, a broader aspect of the invention is to provide a docking station module for portable communication device. The docking station module includes a main module that includes a first transmission interface configured to connect to a portable communication device; a second transmission interface configured to connect to a peripheral device adapter module which is connected to a peripheral device; a power input device for receiving an input voltage; a main transmission node unit connected to the first transmission interface and the second transmission interface for controlling the data transfer between the first transmission interface and the second transmission interface; and a power converter unit connected to the power input interface, the first transmission interface, the second transmission interface, and the main transmission node unit for converting the input voltage into an output voltage. As the second transmission interface is connected to the peripheral device adapter module, the peripheral device can conduct one-way or two-way data transfer with the portable communication device and execute the extension function.

Now the foregoing and other features and advantages of the present invention will be best understood through the following descriptions with reference to the accompanying drawings, wherein:

### BRIEF DESCRIPTION OF THE DRAWINGS

FIG. 1A is a block diagram showing the docking station module for portable communication device according to a first exemplary embodiment of the invention;

FIG. 1B is a block diagram showing the docking station module for portable communication device according to a second exemplary embodiment of the invention;

FIG. 1C is a block diagram showing the docking station module for portable communication device according to a third exemplary embodiment of the invention;

FIG. 1D is a block diagram showing the docking station module for portable communication device according to a fourth exemplary embodiment of the invention; and

FIG. 2 is a block diagram showing an extended modification of the docking station module by combining the block diagram of FIG. 1A and FIG. 1C.

### DETAILED DESCRIPTION OF THE PREFERRED EMBODIMENT

Several exemplary embodiments embodying the features and advantages of the present invention will be expounded in following paragraphs of descriptions. It is to be realized that the present invention is allowed to have various modification in different respects, all of which are without departing from the scope of the present invention, and the description herein and the drawings are intended to be taken as illustrative in nature, and are not intended to be taken as a confinement to limit the invention.

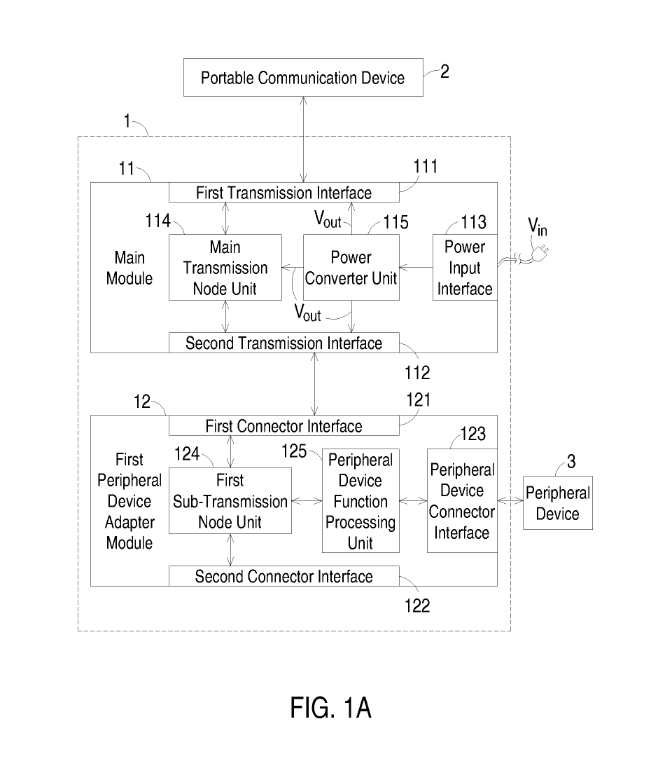

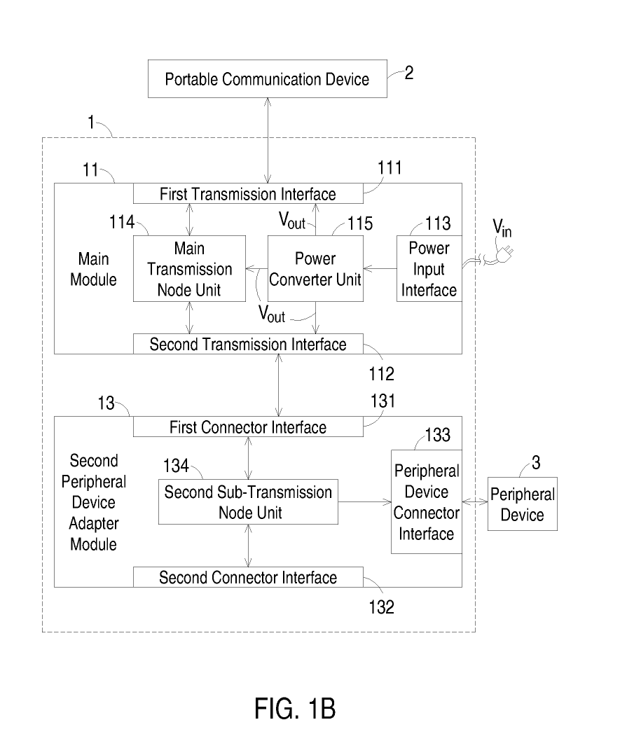

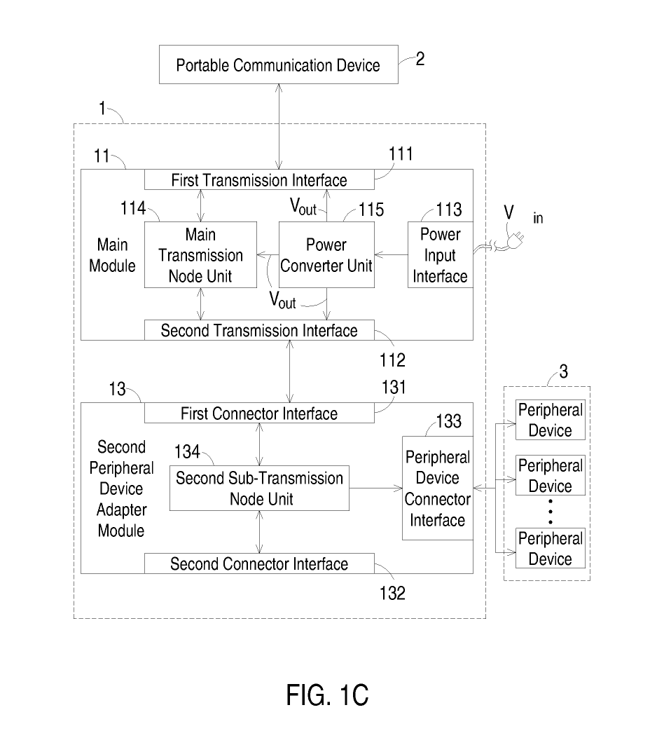

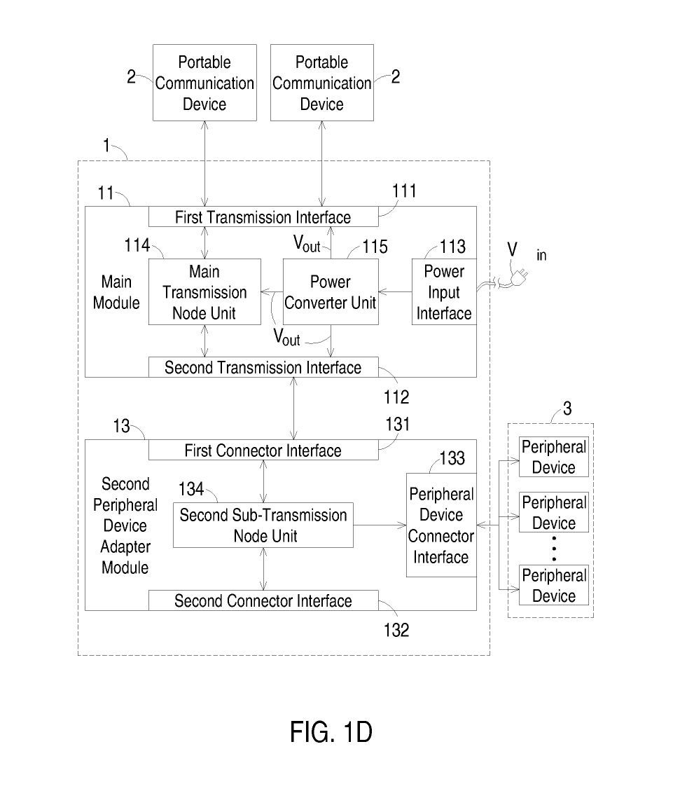

Referring to FIG. 1A, the docking station module for portable communication device according to a first exemplary embodiment of the invention is shown. As shown in FIG. 1A, the docking station module 1 is detachably connected to a portable communication device 2. The docking station module 1 includes a main module 11 and at least one peripheral device adapter module, e.g. a first peripheral device adapter module 12. In the present embodiment, the main module 11 is configured to connect to the portable communication device 2 and thereby charging the portable communication device 2. The first peripheral device adapter module 12 is detachably connected to the main module 11 and a peripheral device 3 and is configured to allow the one-way or two-way data transfer between the portable communication device 2 and a peripheral device 3 and execute the extension function of the first peripheral device adapter module 12.

Referring to FIG. 1A again, the main module 11 includes a first transmission interface 111, a second transmission interface 112, a power input interface 113, a main transmission node unit 114, and a power converter unit 115. The first transmission interface 111 is configured to connect to the portable communication device 2, such as a smart phone. The second transmission interface 112 is configured to connect to the first peripheral device adapter module 12. The power input interface 113 is used to receive an input voltage Vin and transmit the input voltage Vin to the power converter unit 115.

The main transmission node unit 114 is connected to the first transmission interface 111 and the second transmission interface 112 for controlling and distributing the data transfer between the first transmission interface 111 and the second transmission interface 112. The data transfer between the first transmission interface 111 and the second transmission interface 112 can be conducted by either transmitting the data signal from the portable communication device 2 to the first peripheral device adapter module 12 or transmitting the data signal from the first peripheral device adapter module 12 to the portable communication device 2.

The power converter unit 115 is respectively connected to the power input interface 113, the first transmission interface 111, the second transmission interface 112, and the main transmission node unit 114 for converting the received input voltage Vin into an output voltage Vout and outputting the output voltage Vout to the portable communication device 2 and the main transmission node unit 114. Therefore, the portable communication device 2 and the main transmission node unit 114 are powered. In the present embodiment, as the second transmission interface 112 is connected to the first peripheral device adapter module 12, the portable communication device 2 transmits a data signal through the second transmission interface 112 and the first peripheral device adapter module 12 in response to user's manipulations, thereby executing the first extension function of the docking station module 1.

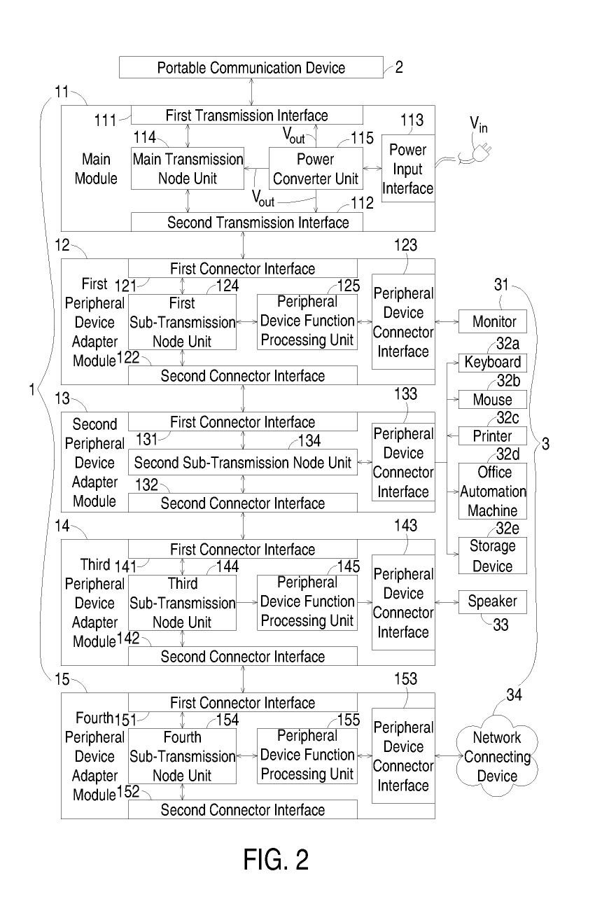

In the present embodiment, the first peripheral device adapter module 12 includes a first connector interface 121, a second connector interface 122, a peripheral device connector interface 123, a first sub-transmission node unit 124, and a peripheral device function processing unit 125. The first connector interface 121 is configured to connect to the second transmission interface 112 of the main module 11. The second connector interface 122 is configured to connect to the first connector interface 131 of the second peripheral device adaptor module 13 shown in FIG. 2 for executing the second extension function of the docking station module 1. The peripheral device connector interface 123 is connected to the peripheral device function processing unit 125 and the peripheral device 3. In the present embodiment, the first connector interface 121, the second connector interface 122, and the peripheral device connector interface 123 may be a USB port.

The first sub-transmission node unit 124 of the first peripheral device adapter module 12 may provide at least three transmission ports (not shown), e.g. a first transmission port, a second transmission port, and a third transmission port. The first transmission port is connected to the first connector interface 121 of the first peripheral device adapter module 12. The second transmission port is connected to the second connector interface 122, and the third transmission port is connected to the peripheral device function processing unit 125 for allowing the first sub-transmission node unit 124 to communicate with the first connector interface 121, the second connector interface 122, and the peripheral device function processing unit 125. In the present embodiment, the transmission ports may be USB ports.

The peripheral device function processing unit 125 may be a video processing IC, an audio processing IC, or an Ethernet processing IC. The peripheral device function processing unit 125 is connected to the first sub-transmission node unit 124 for receiving the data signal of the portable communication device 2 which is outputted from the second transmission interface 112 of the main module 11, and processing the data signal and outputting the processed data signal to the peripheral device 3. For example, the video processing IC may process the data signal and output the image signal tailored for the monitor 31 to the monitor 31. Or otherwise, the audio processing IC may process the data signal and output the audio signal tailored for the speaker 33 to the speaker 33. Or otherwise, the data signal may be processed by Ethernet processing IC to implement the routing for different communication interfaces, for example, RJ-45 interface, WiFi interface, WiMax interface, Zigbee interface, or UWB communication module.

In the present embodiment, the docking station module 1 may be implemented by the main module 11 solely or implemented by the main module 11 as well as the first peripheral device adapter module 12. The first peripheral device adapter module 12 may be detachably connected to and combined with the main module 11. In other embodiments, the peripheral device function processing unit 125 may process the data signal inputted from the peripheral device 3 such as a monitor 31 or an Ethernet connecting device 34 shown in FIG. 2 and transmit the processed data signal to the first sub-transmission node unit 124. Further, the processed data signal may be transmitted to the portable communication device 2.

Referring to FIG. 1B, the docking station module for portable communication device according to a second exemplary embodiment of the invention is shown. As shown in FIG. 1B, the docking station module 1 is detachably connected to a portable communication device 2. The docking station module 1 includes a main module 11 and a second peripheral device adapter module 13. The configuration and connecting topology of the main module 11 of FIG. 1B is similar to the configuration and connecting topology of the main module 11 of FIG. 1A. However, the second transmission interface 112 of the main module 11 is connected to a first connector interface 131 of the second peripheral device adapter module 13 for transmitting a data signal of the portable communication device 2 through the second transmission interface 112 and the second peripheral device adapter module 13, thereby executing the first extension function of the docking station module. The second peripheral device adapter module 13 includes a second connector interface 132, a peripheral device connector interface 133, and a second sub-transmission node unit 134.

The second connector interface 132 is connected to the first connector interface 141 of the third peripheral device adapter module 14 shown in FIG. 2 in response to user's demands for executing the second extension function of the docking station module 1. The peripheral device connector interface 133 is connected to the second sub-transmission node unit 134 and the peripheral device 3. The peripheral device 3 may be a printer, an office automation machine, a keyboard, a mouse, or a storage device. In the present embodiment, the first connector interface 131, the second connector interface 132, and the peripheral device connector interface 133 of the second peripheral device adapter module 13 may be USB ports.

The second sub-transmission node unit 134 of the second peripheral device adapter module 13 may provide at least three transmission ports (not shown), e.g. a first transmission port, a second transmission port, and a third transmission port. The first transmission port is connected to the first connector interface 131 of the second peripheral device adapter module 13. The second transmission port is connected to the second connector interface 132, and the third transmission port is connected to the peripheral device connector interface 133 for receiving the data signal of the portable communication device 2 outputted from the second transmission interface 112 of the main module 11 and output the data signal to the peripheral device 3 through the peripheral device connector interface 133. In the present embodiment, the transmission ports may be USB ports.

In some embodiments, the second peripheral device adapter module 13 may transmit the data signal inputted from the peripheral device, e.g. an input device such as a keyboard 32a or a mouse 32b, to the portable communication device 2 through the second sub-transmission node unit 134 and the main module 11. Also, the docking station module 1 is implemented by detachably combining the main module 11 and the second peripheral device adapter module 13. In some embodiments, the peripheral device connector interface 133 may include a plurality of USB ports, as shown in FIG. 1C, for connecting to a plurality of peripheral devices 3. In some embodiments, the first transmission interface 111 of the main module 11 may connect to a plurality of portable communication devices 2, as shown in FIG. 1D, for independently receiving each data signal from the portable communication device 2 and transmitting each data signal to the portable communication device 2. Therefore, the portable communication device 2 may be extensively supported by the docking station module 1.

Referring to FIG. 2 and FIGS. 1A and 1C, in which FIG. 2 is a block diagram showing an extended modification of the docking station module by combining the block diagram of FIG. 1A and FIG. 1C. As shown in FIG. 2 and FIGS. 1A and 1C, the docking station module 1 includes a main module 11 and a plurality of peripheral device adapter modules, e.g. a first peripheral device adapter module 12, a second peripheral device adapter module 13, a third peripheral device adapter module 14, and a fourth peripheral device adapter module 15. The main module 11 may be detachably connected to or combined with any one of the peripheral device adapter module, and the peripheral device adapter modules may be de detachably connected to or combined with each other. As the portable communication device 2 is connected to the main module 11, the main module 11 receives the data signal from the portable communication device 2 and transmits the data signal to the portable communication device 2 through the first transmission interface 111 and the second transmission interface 112. The main module 11 may receive an input voltage Vin and charge the portable communication device 2.

In the present embodiment, the first connector interface 121 is connected to the second transmission interface 112. The second connector interface 122 is connected to the first connector interface 131. The second connector interface 132 is connected to the first connector interface 141. Likewise, the second connector interface 142 is connected to the first connector interface 151. The second connector interface 152 is connected to the first connector interface of another peripheral device adapter module (not shown). In other words, the peripheral device adapter modules 12-15 are detachably connected in series with each other and connected to the main module 11, thereby allowing various data signals of the portable communication device 2 received by the main module 11 to be relayed in turn to the peripheral device adapter modules 12-15. Therefore, the first extension function, the second extension function, the third extension function, and the fourth extension function of the docking station module are executed. Furthermore, the data signals are outputted to each peripheral device 3 through the transmission node units (124, 134. 144, 154), the peripheral device function processing units (125, 145, 155), and the peripheral device connector interfaces (123. 133, 143, 153). The peripheral devices 3 may include a monitor 31, a printer 32c, an office automation machine 32d, a storage device 32e, a speaker 33, and a network connecting device 34. Alternatively, the data signals inputted from the peripheral devices may be transmitted to the portable communication device 2 through the peripheral device function processing units (125, 135, 145, 155) and the main module 11. The monitor 31 may be a touch panel.

In some embodiments, the input voltage Vin received by the main module 11 or the output voltage Vout may be used to charge the peripheral devices 3 connected to the peripheral device adapter modules (12, 13, 14, 15).

From the above description, the present invention provides a docking station module for portable communication device that is implemented by a main module or a main module as well as at least one peripheral device adapter module for lowering the cost and enhancing the feasibility of maintenance. In addition, the inventive docking station module for portable communication device can connect to a plurality of portable communication devices for selectively receiving the data signals from the portable communication devices and transmitting the data signals to the portable communication devices. Also, the inventive docking station module can allow the peripheral device adapter module to be detached from the docking station module or attached to the docking station module depending on user's demands.

While the invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the invention which is defined by the appended claims.

What is claimed is:

1. A docking station module for a portable communication device, comprising:
a main module configured to connect to a portable communication device for charging the portable communication device; and
at least one peripheral device adapter module detachably connected to the main module and a peripheral device, and configured to allow one-way or two-way data transfer between the portable communication device and the peripheral device and execute an extension function of the peripheral device adapter module.

2. The docking station module according to claim 1 wherein the main module includes:
a first transmission interface configured to connect to the portable communication device;
a second transmission interface configured to connect to the peripheral device adapter module;
a power input interface for receiving an input voltage;
a main transmission node unit connected to the first transmission interface and the second transmission interface for controlling data transfer between the first transmission interface and the second transmission interface; and
a power converter module connected to the power input interface, the first transmission interface, the second transmission interface, and the main transmission node unit for converting the input voltage into an output voltage.

3. The docking station module according to claim 2 wherein the peripheral device adapter module includes:
a first connector interface configured to connect to the second transmission interface of the main module;
a second connector interface configured to connect to another peripheral device adapter module;
a peripheral device connector interface configured to connect to the peripheral device;
a first sub-transmission node unit connected to the first connector interface and the second connector interface for controlling data transfer between the first connector interface and the second connector interface; and
a peripheral device function processing unit connected to the first sub-transmission node unit for receiving a data signal of the portable communication device and executing the extension function.

4. The docking station module according to claim 3 wherein the peripheral device includes a monitor, a speaker, or a network connecting device.

5. The docking station module according to claim 2 wherein the peripheral device adapter module includes:
a first connector interface configured to connect to the second transmission interface of the main module;
a second connector interface configured to connect to another peripheral device adapter module;
a peripheral device connector interface configured to connect to the peripheral device; and
a first sub-transmission node unit connected to the first connector interface and the second connector interface for controlling data transfer among the first connector interface, the second connector interface, and the peripheral device connector interface.

6. The docking station module according to claim 5 wherein the peripheral device includes a keyboard, a mouse, a printer, an office automation machine, or a storage device.

7. The docking station module according to claim 1 wherein the docking station module comprises a main module and a plurality of peripheral device adapter modules detachably connected in series with each other and connected to the main module.

8. A docking station module for a portable communication device, comprising:
a main module configured to connect to a portable communication device for charging the portable communication device; and
a plurality of peripheral device adapter modules detachably connected in series with each other and connected to the main module and respectively connected to a plurality of peripheral devices, and configured to allow one-way or two-way data transfer between the portable communication device and the peripheral devices and execute an extension function of the peripheral device adapter modules.

9. The docking station module according to claim 8 wherein the main module is used to receive an input voltage and provide an output voltage, and the input voltage or the output voltage is used to charge the plurality of peripheral devices connected to the plurality of peripheral device adapter modules.

10. A docking station module for a portable communication device, comprising:
a main module, comprising:
a first transmission interface configured to connect to a portable communication device;
a second transmission interface configured to connect to a peripheral device adapter module which is connected to a peripheral device;
a power input interface for receiving an input voltage;
a main transmission node unit connected to the first transmission interface and the second transmission interface for controlling data transfer between the first transmission interface and the second transmission interface; and
a power converter module connected to the power input interface, the first transmission interface, the second transmission interface, and the main transmission node unit for converting the input voltage into an output voltage;
wherein as the second transmission interface is connected to the peripheral device adapter module, the peripheral device is allowed to proceed with one-way or two-way data transfer with the portable communication device and execute an extension function.
